(19) United States
(12) Patent Application Publication
(10) Pub. No.: US 2024/0253822 A1
(43) Pub. Date: Aug. 1, 2024

(54) Multi-Pressure Space Habitat

(71) Applicant: Radiant Space Systems, Inc., Santa Clara, CA (US)

(72) Inventors: Lee Laponder Wilson, San Jose, CA (US); Joseph Mark Oorebeek, Palo Alto, CA (US)

(21) Appl. No.: 18/413,009

(22) Filed: Jan. 15, 2024

Related U.S. Application Data
(60) Provisional application No. 63/441,803, filed on Jan. 29, 2023.

(51) Int. Cl. B64G 1/48; B64G 1/60

(52) U.S. Cl. CPC B64G 1/48; B64G 1/60

(57) ABSTRACT

A habitat that may be constructed in space or on a celestial body having an atmosphere (or the lack thereof) that is inhospitable to human life. The habitat is contained in a hull having at least two walls, each wall comprising at least a flexible pressurizable membrane configured to retain an atmospheric pressure, such that a first wall encloses a first volume, and a second wall encloses a second volume that is contained within the first volume. In operation, the pressure on the inner side of each pressurizable membrane is equal to or greater than the pressure on the outer side of that pressurizable membrane. The walls may be separated by a sufficient distance to allow for inspection and/or repair. Walls may include micrometeoroid shielding, a thermal layer, a structural layer, and/or an architectural layer. The habitat may include a section that spins to generate artificial gravity.

This application claims priority from Provisional Application No. 63/441,803, filed Jan. 29, 2023, which is incorporated by reference herein in its entirety.

### FIELD OF THE INVENTION

The present invention relates generally to space exploration, and more particularly to a habitat for use in space or other non-earth environments.

### BACKGROUND OF THE INVENTION

Traditional orbital space habitats, like the International Space Station, are made from rigid modules that are built and tested on the ground. Their walls need to be strong enough to contain an atmosphere that can sustain human life and to withstand micrometeoroid impacts, while their size is limited by the size of the payload fairing on the launch vehicle transporting them into orbit. Any leaks in the habitat must be dealt with very quickly due to the relatively small volume of air in the habitat.

One alternative option that has been explored by the National Aeronautics and Space Administration (“NASA”) in cooperation with private enterprise is the use of expandable habitats. Examples of such habitats are disclosed in U.S. Pat. Nos. 6,962,310 and 6,547,189. The habitats described in these patents are flexible and can thus be packaged more tightly into a payload fairing, and then expanded into a larger volume once in orbit. To protect from leaks and micrometeoroids, there are multiple layers of leak-proof material behind micrometeoroid and radiation shielding.

A key challenge with such habitats is that the habitat wall is made with all these layers close together, making it very difficult to inspect the various layers for leaks and holes, and even harder to repair the wall if a leak or hole is found. The micrometeoroid shielding needs to be very thick and is not accessible from the inside.

An expandable habitat that allows access to the various functional layers needed to sustain life in space or on a celestial body is desirable.

### SUMMARY OF THE INVENTION

Described herein is an improved habitat that may be constructed in space or on a celestial body having an atmosphere (or the lack thereof) that is inhospitable to human life.

One embodiment is directed to a structure for use in an environment having an ambient atmospheric pressure, comprising: a first wall comprising a flexible pressurizable membrane layer configured to enclose a first volume having a first atmospheric pressure that is greater than the ambient atmospheric pressure outside the first wall; a second wall comprising a flexible pressurizable membrane layer configured to enclose a second volume having a second atmospheric pressure that is greater than the ambient atmospheric pressure and greater than the first atmospheric pressure, wherein the second wall is located within the first volume at a distance from the first wall; a first sensor configured to detect an indication of a change in the first atmospheric pressure; and a control system configured to adjust the first atmospheric pressure in response to a detected indication of change in the first atmospheric pressure by the sensor.

In a further embodiment, the structure further comprises an airlock that provides access between the second volume and the first volume between the first wall and the second wall.

In a still further embodiment, the structure further comprises an airlock that provides access between the environment and the first volume between the first wall and the second wall.

In a yet further embodiment, the structure further comprises a third wall extending from the first wall to the second wall and enclosing a portion of the first volume between the first wall and the second wall thereby defining a cell between the first wall and the second wall.

In a yet still further embodiment, the structure further comprises a third wall comprising a sheet of flexible pressurizable membrane configured to be attached at its edges to the first wall; whereby a third volume is created within the first volume, the third volume having a third atmospheric pressure that is less than or equal to the first atmospheric pressure and greater than the ambient atmospheric pressure.

### BRIEF DESCRIPTION OF THE DRAWINGS

FIG. 1 is an isometric view of the outside of a habitat in one embodiment of the present approach.

FIG. 2 is a side cross-section view of a habitat in one embodiment of the present approach.

FIG. 3 is a top cross-section view of the habitat of FIG. 2 in one embodiment of the present approach.

FIG. 4 is a front cross-section view of the habitat of FIG. 2 in one embodiment of the present approach.

FIG. 5 is an isometric cross-section view of a habitat in another embodiment of the present approach.

FIG. 6 is a front cross-section view of a habitat in another embodiment of the present approach.

### DETAILED DESCRIPTION OF THE INVENTION

Described herein is an improved habitat that may be constructed in space or on a celestial body having an atmosphere (or the lack thereof) that is inhospitable to human life.

A habitat adapted for living and/or working in outer space or on another celestial body under the present approach utilizes a hull having at least two walls, each wall comprising at least a flexible pressurizable membrane configured to retain atmospheric pressure, such that a first wall defines a first volume, and a second wall defines a second volume that is contained within the first volume. The habitat is constructed such that in operation, the pressure on the inner side of each pressurizable membrane is equal to or greater than the pressure on the outer side of that pressurizable membrane. The walls may be separated by a sufficient distance to allow for inspection and/or repair by a person or robot.

A habitat constructed under the present approach improves upon existing expandable habitat designs by improving access to each pressurizable membrane to facilitate inspection and repair in the event that any pressurizable membrane develops a leak. If a leak does occur, pumps or compressors may be utilized to maintain a desired pressure within each membrane. This is in opposite fashion to bilge pumps in a ship; in a ship, water is pumped back out into the ocean, i.e., the environment; under the present approach a pump or compressor may be used to pump air back from the volume enclosed by a first membrane into the volume enclosed by a second membrane that is within the first volume. Thus, air may be returned to the habitat instead of letting it escape (except in the case of the outer membrane, where air may escape into the environment).

In some embodiments under the present approach, each pressurizable membrane has at least one air-retention membrane which is clearly visible, allowing for inspection, quick identification of leak locations and potential repair. If a pressurizable membrane is damaged, an astronaut or drone may be able to repair the pressurizable membrane without needing to do an extravehicular activity (“EVA”) outside the habitat. This avoids the risk of losing tools and hardware in space and helps to protects an astronaut or drone from thermal extremes.

In some situations, the astronaut may not even need to wear a full spacesuit, potentially improving the astronaut's dexterity and efficiency in completing the task. In addition, in some cases a region between pressurizable membranes may be temporarily pressurized to a higher pressure to aid an astronaut in this work. By utilizing multiple pressurizable membranes, air leaking through any given pressurizable membrane can be recaptured, thus improving habitat safety.

Traditional habitats are designed to ensure the habitat is effectively indestructible, to minimize the need for repairs in space, and to outfit the habitat with most of the equipment it needs, including radiation shielding, while the habitat is constructed on Earth. The resulting habitat designs are thus highly volume constrained, and this has precluded solutions that provide thick hulls while still providing large internal volumes that could be used for astronaut living and working areas.

Further, in a traditional design, the outer wall surrounding a habitat is rigid and must perform a variety of functions. In addition to retaining air pressure, the wall must provide protection against micrometeoroids and radiation and insulation against the cold of space. Thus, such a wall requires a number of layers, each layer having a different function, that are “sandwiched” together to create a single wall structure. This makes it difficult or impossible to access some of the layers without destroying the wall in case of a problem, and thus in some instances may necessitate replacing the entire wall even if only a single layer is compromised in some fashion.

Under the present approach, the walls comprise pressurizable membranes that are flexible so that they can be deployed and expanded in space rather than rigidly constructed on Earth, after which a human or robot can go through an airlock and attach radiation and micrometeoroid shielding on the outside of the outermost membrane. This allows for the shielding to be launched on a separate launch vehicle from the hull, and the space on the rocket that would normally be used for shielding can be taken up by more hull material instead.

A larger hull means a less space constrained habitat that can thus include both larger internal living and working volume and a thicker hull with separation between pressurizable membranes. Having a plurality of membranes allows for other layers, such as shielding or insulation, to be attached to different layers, thus providing easier access to the various layers for inspection or repair. As above, in some embodiments, the separation of membranes is sufficient to allow access by a person or robot.

Under the present approach, the absolute pressure between the pressurizable membranes may decrease toward the exterior. This pressure may be maintained by pumps or compressors, which allows any air that leaks through one pressurizable membrane to be pumped back into the next inner layer or the center of the habitat. The region adjacent to the outer wall may be at near-vacuum, with pumps recycling any air that leaks through back into the habitat faster than it can leak through the outer wall.

In some cases, micrometeoroid and radiation shielding may be mounted on the exterior face of the next pressurizable membrane in from the outer membrane. The micrometeroid shielding affixed to the outer wall may include a Whipple shield, such that when a micrometeoroid impacts the Whipple shield, it fragments and the now smaller fragments then travel in a cone similar to a shotgun blast, thus minimizing potential damage.

Holes created by a micrometeoroid in the outermost wall will be small, and very little air may leak through since, as above, in some embodiments the region between the outside wall and a next inner wall is near vacuum by default. This may provide time for a person or robot or other method of repair to travel to the hole location to repair it. As above, travelling behind the leaking pressurizable membrane, rather than outside it, protects an astronaut or robot from thermal effects and from the possibility of them or their tools floating away from the habitat. In addition, as above, this region may be pressurized to allow a human to operate without a spacesuit depending on the hole size.

The present approach to hull design may be used for other space structures that require internal pressure, such as large airlocks and spaceships, or for structures located on other celestial bodies on which the atmosphere, or lack thereof, is unsuitable to support human life, such as the moon or Mars. As described earlier, habitat design using the present approach allows for much larger habitats that are able to be packaged into the same payload fairing volume

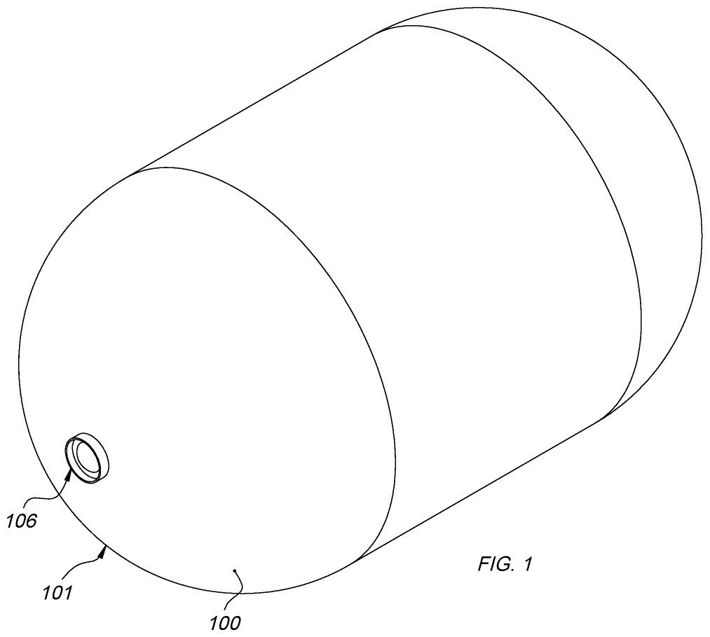

FIG. 1 is an isometric view of the outside of a habitat 100 adapted for living and/or working in outer space in one embodiment of the present approach. The habitat 100 may additionally or alternatively be adapted for living and/or working on the surface of non-terrestrial celestial bodies. The habitat 100 comprises a hull 101 including at least two flexible pressurizable membrane walls. As illustrated herein, habitat 100 has a generally cylindrical shape with rounded ends; other shapes are possible, but one of skill in the art will appreciate that a cylindrical, elliptical or spherical shape may be most suitable to distribute the stress on hull 101 from the atmospheric pressure inside.

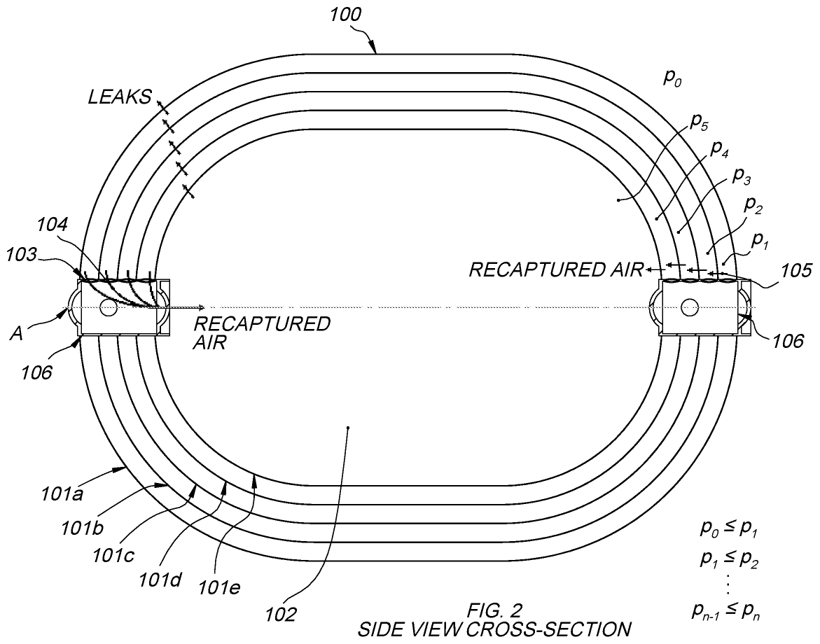

FIG. 2 is a side cross-section of a habitat 100 in one embodiment of the present approach in which the hull 101 of habitat 100 comprises five flexible pressurizable membrane walls 101a, 101b, 101c, 101d, and 101e.

As illustrated in FIG. 2, the membrane walls 101a-101e in hull 101 are pressurized such that in nominal operation, the pressure on the inner side of each pressurizable membrane wall is equal to or greater than the pressure on the outer side of the same pressurizable membrane wall. (In some embodiments the opposite may be true if the region between the pressurizable membrane walls is further subdivided into cells as is described later.)

Each wall comprises a flexible pressurizable membrane 101a-101e configured to retain atmospheric pressure. A given wall may also include, but is not limited to, a structural shell or membrane used for distributing stress, a thermal layer or coating to control heat transmission, a micrometeoroid shield, and an architectural layer used to create attachment points to which hardware may be mounted.

While a wall may include any number of these layers in addition to the pressurizable membrane, one of skill in the art will appreciate that every wall need not include all of these layers, and that in various embodiments it may be preferable that certain walls will contain certain layers. For example, when there are two walls, shielding for micrometeoroids will typically be located on the outer surface of the outer wall such as a Whipple shield, and not be included on the inner wall. A structural layer may be most useful on the inner wall, which is subject to greater interior pressure than the outer wall. A thermal layer designed to minimize heat transfer via radiation may be located on the outer wall where the pressure is lowest, while a thermal layer on inner walls may incorporate additional elements to reduce conduction and convection heat transfer as well. An architectural layer may most likely be useful on the inner surface of the inner wall to provide attachment points for hardware and prevent damage to the pressurizable membrane.

One of skill in the art will appreciate that various materials may be used for the various layers. For example, Controlled Environment Packaging (Cepac) HD-200 may be used for the air-retention layers. A micrometeoroid shield may contain layers of impacting material such as Nextel fiber separated by spacer layers such as foam. A thermal layer on the outer wall, where heat loss is due to radiation, may be aluminized Mylar or Kapton. Kevlar or Vectran broadcloth and/or webbing may be for the structural membranes or architectural layers; however, since a structural layer is used for strength, it may be of a thicker material than an architectural layer, for which tear resistance is more important.

When a third (or more) wall is added in between the first (outer) wall and the second (inner) wall, it may resemble the inner wall more than the outer wall. Thus, for example, while under the present approach a third wall will also contain a flexible pressurizable membrane configured to retain atmospheric pressure, it may not be necessary for the third wall to include a micrometeoroid shield or architectural layer, but in some embodiments it may be desirable for the third wall to include a structural layer. Similarly, since the third wall will have atmospheric pressure on both sides of the wall, heat loss due to forced convection and/or conduction may be higher, and thus a thermal layer of some insulating material such as polystyrene may be used on the third wall in place of, or in addition to, the Mylar or Kapton that is used on the first outer wall.

One of skill in the art will also appreciate that there are various ways of attaching the layers together in a wall. In some cases the layers may be bonded together in some fashion, while in other cases simpler methods may be used. For example, to secure the radiation shielding on the outer wall, e.g. sheets of Mylar or Kapton (polyethylene), the sheets may simply be tied down to an exposed Vectran or Kevlar structural layer that has been attached to a pressurizable membrane.

The habitat 100 may be of any suitable or desired size. In some embodiments the habitat 100 may have a length between about 10 meters (“m”) and about 70 meters, and a diameter between about 12 meters and 40 meters. These dimensions will vary based upon the payload capacity of a launch vehicle, and the volume required to hold the folded flexible walls of the collapsed habitat; as launch vehicle capabilities increase habitat dimensions may also increase. In one embodiment, the habitat 100 has a length of 47 meters and a diameter of 27 meters. In other embodiments the habitat may be fully unmanned and have much smaller dimensions of, for example, 3 meters.

Various hardware may be mounted external to the outermost pressurizable membrane wall 101a, such as solar arrays for energy collection, radiators for waste heat rejection, communications antennas, propulsive systems, surface lighting and livery/markings, among others. One or more airlocks 106 may provide both the capacity to dock with transport vehicles, as well as allow ingress and egress of astronauts in pressure suits, or the hand launching or deployment of satellites. Airlock 106 may also be sized for the ingress and egress of equipment and objects instead of people. In some embodiments airlock 106 may not be dockable. An airlock 106 may also provide access to the interstitial volume between the pressurizable membrane walls 101a-101e. Airlock 106 may also be used to join multiple habitats or other modules together.

Construction of the habitat 100 according to the present approach allows for assembly and testing on the ground, after which the habitat may be deflated and packaged for transport in such a way as to fit inside the fairing of a launch vehicle. In one embodiment, the habitat 100 may be sized such that it can be transported by SpaceX's Starship in its deflated configuration. SpaceX's Starship fairing has a diameter of 8 meters and a length of 17 meters. Smaller embodiments of a habitat may be transported on smaller launch vehicles, while in the future, it is expected that larger habitats may be transported on larger launch vehicles.

Gas stored in a compressed form, or as a liquid or solid, may be used to inflate the various flexible pressurizable membrane walls 101a-101e and create the central pressurized volume 102; one of skill in the art will appreciate that the mass of gas required to inflate any given wall will depend upon the pressure desired within the volume contained by that wall, the size of the volume between that wall and the next inner wall (or the size of the central pressurized volume 102) in, e.g., cubic feet or cubic meters, and the composition of gas used. Additional components which are not amenable to compressed storage (such as impact and/or radiation shielding) may be shipped with the habitat 100 in disassembled state and re-assembled in orbit, or launched separately and re-assembled or integrated with the habitat in orbit. Frames may be added to help maintain the shape of any or all of the pressurizable membrane walls 101a-101e, for example, in the event of an atmospheric leak in any of the pressurizable membranes. Assembly of the frames may be done through robotics or manual human labor.

Pumps, compressors and/or vent valves or other similar technology 103 may be located between the pressurizable membrane walls 101a-101e and used to maintain target pressure gradients across the pressurizable membrane walls. The pumps, compressors and/or vent valves 103 also recapture any air that leaks through a pressurized membrane. The recaptured air may be pumped back to the central pressurized volume 102 via the airlock 106, as shown by arrows 104 in FIG. 2. Air may also be pumped across pressurized membranes; arrows 105 illustrate the direction of pumped air to counter leaks.

In one embodiment of habitat 100, the pressure p₁ between the outermost membrane walls 101a and 101b is maintained as close to the external pressure, p₀, as possible. If the outer membrane wall 101a is damaged by micrometeoroids, the low-pressure differential between p₀ and p₁ means minimal air is lost prior to being repaired. In one embodiment, nominal pressures in the example shown in FIG. 2 could be p₀=0 atmospheres (atm), p₁ is approximately 0 atm and central pressurized volume at p₅=1 atm. For identical pressure differentials across pressurizable membrane walls 101b-101e, one option is p₂=¼ atm, p₃=½ atm and p₄=¾ atm.

In one embodiment the gaps between membrane walls, such as 101a and 101b, or 101b and 101c, etc. are large enough to allow humans or robots or other methods of repairing to repair any leaks and damage. For humans the gap may be between 0.5 meters and 2 meters, and for drones or robots the gap may be about 0.05 meters to 0.5 meters. For a gap to be sized to allow for repair, the gap must be large enough for the repairer to fit; the upper limit is governed by the tradeoff between the gap volume and the central pressurized volume 102 used for living and working inside the habitat 100. An additional benefit is that in the event a micrometeoroid penetrates through any micrometeoroid shielding, a larger the gap between the outer two membrane walls 101a and 101b may result in a larger fragmentation cone created when a micrometeoroid impacts 101a results in a lower resulting force from the impact on membrane 101b.

In certain circumstances it may be beneficial to temporarily increase the pressures such that all of the interstitial pressures are nearly equal, i.e., p₁≈p₂≈p₃≈p₄≈p₅, while still maintaining a small pressure differential between each gap, i.e., p₁<p₂<p₃<p₄<p₅. Such circumstances might include allowing people to install radiation or micrometeoroid shielding, or structural ribs to provide additional structural rigidity, between, for example, membrane walls 101a and 101b without the need for a spacesuit.

Sensors may feed telemetry to a control system to control the pressures p₁ to p₅; as would be understood by one of skill in the art in light of the teachings herein, the control system may comprise, for example, a computer, processor, or logic circuitry that is configured to control the various pressures by operating the compressor, pump and/or valves in a given embodiment. These sensors may include strain gauges placed within the structural layer of the pressurizable membrane walls 101a-101e and/or pressure gauges mounted between the pressurizable membrane walls 101a-101e, in the central pressurized volume 102, or in the airlocks 106. Other types of sensors may include flow meters to measure gas flow rate, or temperature sensors measuring the temperature of the pressurizable membrane walls 101a-101e or of the gas between them. Acoustic sensors may also be incorporated into the control system to listen for any acoustic cues for leaks or damage. Performance characteristics of the compressor or pump, including power consumption and pump RPM, may also be used by the control system. Changes in any of this telemetry may be used to determine the size, location and number of any leaks or amount of damage in the membranes, in addition to maintaining correct pressures between the pressurizable membrane walls 101a-101e and within the central pressurized volume 102.

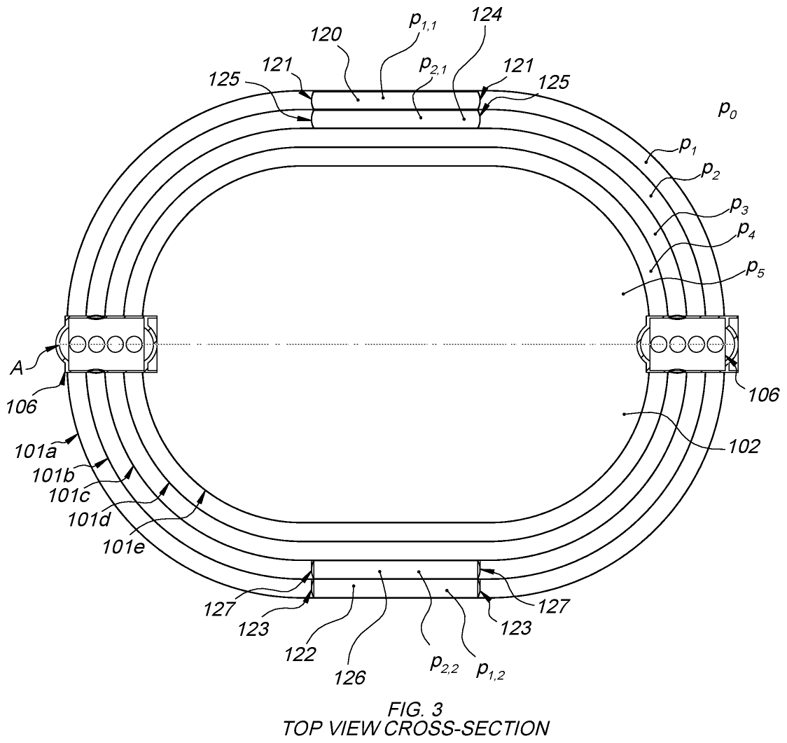

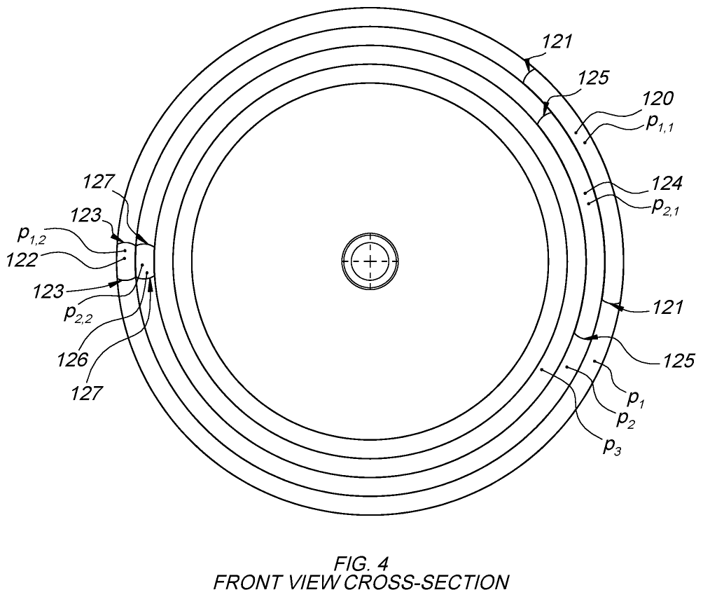

FIG. 3 is a top cross-section view of the habitat of FIG. 2 in one embodiment of the present approach. FIG. 4 is a front cross-section view of the habitat of FIG. 2 in one embodiment of the present approach. FIGS. 3 and 4 illustrate how the regions between the pressurizable membrane walls 101a-101e may be further subdivided into separate cells via radial and circumferential cell walls. In FIGS. 3 and 4, for clarity of illustration only four cells 120, 122, 124, 126 are shown.

In the illustrated embodiment of habitat 100, cell 120 is located between pressurizable membrane walls 101a and 101b, has an atmospheric pressure p_{1,1} and is surrounded by cell walls 121. Cell 122 is between pressurizable membrane walls 101a and 101b, has pressure p_{1,2} and cell walls 123. Cell 124 is between pressurizable membrane walls 101b and 101c, has pressure p_{2,1} and cell walls 125. Cell 126 is between pressurizable membrane walls 101b and 101c and has pressure p_{2,2} and cell walls 127.

An advantage of implementing such cells is that if a leak occurs in a given cell, only the atmosphere of that cell is affected. Leaks are also more quickly detected because there is less air within a cell, and so a given leak causes the pressure within the cell to drop more quickly. In some embodiments access to cells may be provided through the airlock 106, or via additional sealable openings between cells, for example, through doors in the cell walls 121, 123, 125 and/or 127. Air may be pumped between cells to control or maintain pressure or to reclaim air in the same fashion that it may be pumped between the pressurizable membrane walls.

Smaller cells may allow the pressure differential across the pressurized membrane walls to be reversed, such that p_{1,2} in cell 122 may be higher than p_{2,2} in cell 126. Cell walls 123 provide extra structural support and stop pressurized membrane wall 101b from collapsing inwards. This potentially allows cell 122 to be pressurized up to p_{1,2}=1 atm, in turn allowing people to work within the cell without needing a spacesuit. This pressurization may be temporary, such as to allow a person to install radiation or micrometeoroid shielding, inspect the cell walls or pressurizable membrane for damage or repair to a slow leak. In some embodiments, the cells may be sealed without access, but include a permanent robot or drone within the cell to effect repairs when needed.

While the number and size of the cells is arbitrary, one of skill in the art will appreciate various considerations that may be considered in their design. Smaller cells will result in less air being lost in the event of leak in a given cell. If, for example, cells such as 120, 122, 124 and 126, are extended all the way around the circumference of a cylindrical habitat (see FIG. 4), the habitat may retain its general shape even if one or cells should lose pressure. In other embodiments a frame may be placed inside a wall to keep the habitat from collapsing if pressure is lost; placing the frame inside the innermost wall may be preferable.

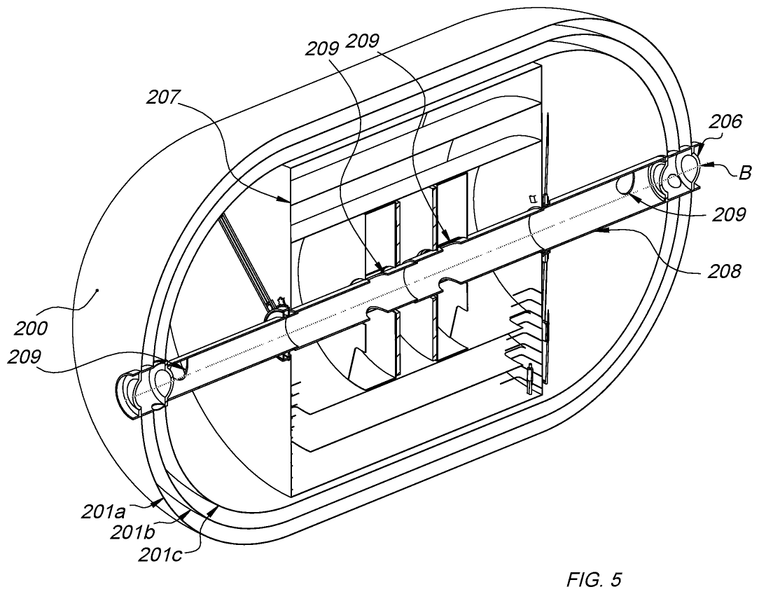

Each cell may be inflated by the pumps, compressors and/or vent valves that are used to maintain the pressure within a given cell. Similar to the gas used to inflate the pressurizable membranes, the gas for use in the cells may be stored during launch in a compressed form, or as a liquid even solid. FIG. 5 is an isometric cross-section view of a habitat in another embodiment of the present approach. In the embodiment of FIG. 5, a habitat 200 comprises a hull 201 with three pressurizable membrane walls 201a, 201b, and 201c (no cells are illustrated although they, too, may be included in a given embodiment). The features and functionality of the pressurizable membrane walls 201a-201c in habitat 200 are the same as the features and functionality of pressurizable membrane walls 101a-101e in habitat 100.

Internal to the hull 201 of habitat 200 is a rotating artificial gravity module, called a spin-section, 207. The spin-section 207 may be used with other hull configurations, and is not limited to use within the hull 201 disclosed herein. In one embodiment, spin-section 207 is 22 meters in diameter and 27 meters long but may range from 6 meters to 25 meters in diameter and from 3 meters to 33 meters long.

As with the habitat size as discussed above, these dimensions may change based on launch vehicle capability and packaging techniques. One of skill in the art will appreciate that a spin section with a larger radius has certain advantages over one with a smaller radius. A larger radius results in more room inside the portion of the habitat with artificial gravity and allows the spin section to spin more slowly to achieve a desired level of artificial gravity. Further, it will be apparent that the movement of people, robots or other equipment within the spin section may cause changes in the location of the center of gravity of the spin section that require correction; a larger radius makes these changes easier to implement. A control system may be used to control operation of the spin section based upon appropriate sensors and logic or programming. In various embodiments, the control system used to control operation of the spin section may be the same as the control system used to control the pressures in the various volumes as described above, while in other embodiments the control system used to control operation of the spin section may be a separate system from that of the pressure control system.

The spin-section 207 is attached to a non-rotating transit tube 208 via bearings and/or motor driver assemblies, and rotates around the axis B of the transit tube 208. The transit tube 208 may be telescoping to allow for compact storage during launch. The transit tube 208 may include multiple sealing hatches 209 for the purposes of sealing off the transit tube 208 from the rest of the habitat 200 or to preserve air pressure in the transit tube 208 in the event of an emergency. The spin-section 207 may be assembled of any combination of rigid, semi-rigid or soft materials. The spin-section 207 or regions within it may be designed to independently hold pressure to habitable levels in the event of an emergency or rupture of the hull 201.

It will be appreciated that each type of launch vehicle has a different payload capacity and volume limit, and that these will limit the size and dimensions of a habitat that may be carried by that type of launch vehicle. For example, for the SpaceX Falcon 9 rideshare configuration, the payload volume the habitat needs to package within is not a sphere or cube, but rather the SpaceX XL volume is 1.168 m high, 1.485 m deep and 3.031 m at its widest point. Further, it may be desirable that the packaged habitat pressurizable membranes be separated by foam, a frame or other structural element to ensure the habitat maintains its shape during deployment, at low pressure or after a leak develops. One example is an open cell, low density, polyurethane foam such as used by NASA for Whipple Shields, which has a stowed-to-deployed thickness ratio of 1:8.

Since the foam or structural element has a finite packaged volume, this will occupy some of the allowed payload volume, and thus may further limit the number of pressurizable membranes that can be stowed in each direction. While the optimum configuration is to have multiple pressurizable membranes separated by a gap around the entire circumference for both inspection and controlling air leaks, the packaged volume in one direction may limit how many pressurizable membranes are feasible.

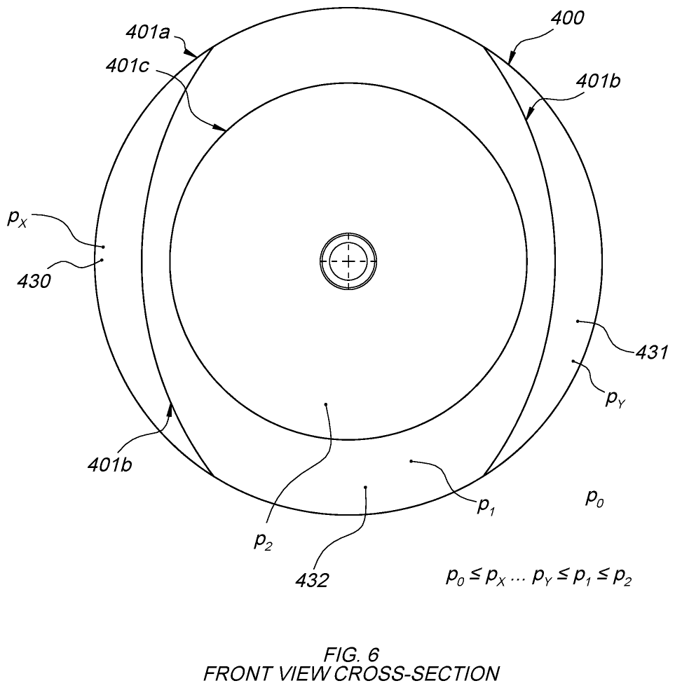

FIG. 6 is a front cross-section view of a habitat in another embodiment of the present approach. In this embodiment, a habitat 400 has a second membrane wall 401b, referred to herein as an “interstitial wall,” that does not completely surround the inner membrane wall 401c, but rather comprises a sheet of a flexible pressurizable membrane that is attached at its edges to a portion of the circumference of the first membrane wall 401a, thus defining an additional enclosed volume 430. Another example of such an interstitial wall is shown that defines another enclosed volume 431. The interstitial membrane walls 401a and 401b may include other layers as described above where appropriate or desirable. The areas between the edges where the interstitial walls are attached fully surrounding an inner membrane wall or interior space would not need to have any foam or other element to separate them, and so the only additional volume occupied by the habitat in the stowed configuration is the volume of the interstitial membrane wall. The effectiveness of the anti-bilge pumps will be reduced in proportion to the reduced circumference not covered by separately pressurizable interstitial membrane walls, but this embodiment may provide some advantages over a configuration in which each wall is independent such as those described above.

The interstitial membrane wall, such as flexible pressurizable membrane wall 401b may be attached to the outer membrane wall 401a (or another membrane wall such as inner membrane wall 401c in some embodiments). If membrane wall 401b is attached to membrane wall 401a by sealing the entirety of the edge or edges of membrane wall 401b to membrane wall 401a, the volumes 430 and 431 will be separately pressurizable from volume 432. In the embodiment of habitat 400 there are two separate pressurizable volumes 430 and 431 with pressures p_{X} and p_{Y}, but there can be an arbitrary number of volumes. Pressures p_{X} and p_{Y} are less than the pressure p₁ in volume 432 between the outer pressurizable membrane wall 401a and the inner pressurizable membrane wall 401c, but greater than the external pressure p₀. Because volumes 430 and 431 are not connected, pressures p_{X} and p_{Y} do not need to be the same pressure.

Like the embodiments described above, the volumes 430 and 431 between the first pressurizable membrane wall 401a and the second pressurizable membrane wall 401b (that is, the interstitial membrane wall) can be further subdivided with cell walls as also described above. Also like the above-described embodiments, pumps, compressors and/or vent valves or other similar technology may be located between the pressurizable membrane walls 401a-401c and used to maintain target pressure gradients across the pressurizable membrane walls. These pumps, compressors and/or vent valves can be used to inflate the habitat 400 as well.

This embodiment also allows for differing numbers of interstitial walls on different sides of the habitat for reasons other than packaging constraints; for instance, since the forward facing side of an orbital habitat is an area most likely to be impacted by micrometeroids and thus is more likely to experience leaks, that side of the habitat may be given priority by having a larger interstitial pressurizable membrane wall. In such a configuration, referring again to FIG. 6, habitat 400 may have walls 401a and 401c completely surrounding the habitat, with a single larger interstitial wall 401b placed such that volume 430 aligns with the front facing side of the habitat and with a greater dimension such that it, while still not completely surrounding inner membrane wall 401c or interior space, covers a much greater portion of the circumference than the examples shown in the figure.

This approach can be used for any habitat where the total external volume is constrained, such as by material mass or stress or payload constraints, whether the habitat is intended to be occupied by humans or unmanned. Where human occupancy is intended, this approach can also be used to vary the distance between pressurizable membranes, such that humans are able to access one or more areas, such as to access equipment, while robots or drones may be used for inspection of any remaining interstitial volumes that are too small for human ingress.

In this way the total mass and complexity of the system may be better optimized for the environment.

By combining these features, it is possible to construct a habitat that is expandable in space and that allows access to the functional layers in the walls for inspection and repair, and minimizes atmosphere loss in the event of a leak. One of skill in the art will appreciate that a habitat of any desired size or shape may be constructed according to these principles.

The disclosed system has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than or in addition to those described above.

For example, as is well understood by those of skill in the art, various choices will be apparent to those of skill in the art. In alternative embodiments, any suitable number of pressurizable membrane walls may be used. Further, the illustration of walls and the associated layers therein is exemplary; one of skill in the art will be able to select the appropriate number of walls, layers and related elements that is appropriate for a particular application.

These and other variations upon the embodiments are intended to be covered by the present disclosure, which is limited only by the appended claims.

What is claimed is:

1. A structure for use in an environment having an ambient atmospheric pressure, comprising:
a first wall comprising a flexible pressurizable membrane layer configured to enclose a first volume having a first atmospheric pressure that is greater than the ambient atmospheric pressure outside the first wall;
a second wall comprising a flexible pressurizable membrane layer configured to enclose a second volume having a second atmospheric pressure that is greater than the ambient atmospheric pressure and greater than the first atmospheric pressure, wherein the second wall is located within the first volume at a distance from the first wall;
a first sensor configured to detect an indication of a change in the first atmospheric pressure; and
a control system configured to adjust the first atmospheric pressure in response to a detected indication of change in the first atmospheric pressure by the sensor.

2. The structure of claim 1 wherein the first wall further comprises a shielding layer located on a surface of the flexible pressurizable membrane layer.

3. The structure of claim 1 wherein the first wall further comprises a structural layer located on a surface of the flexible pressurizable membrane layer.

4. The structure of claim 1 wherein the first wall further comprises a thermal layer located on a surface of the flexible pressurizable membrane layer.

5. The structure of claim 1 wherein the second wall further comprises a structural layer located on a surface of the flexible pressurizable membrane layer.

6. The structure of claim 1 wherein the second wall further comprises a thermal layer located on a surface of the flexible pressurizable membrane layer.

7. The structure of claim 1 wherein the second wall further comprises an architectural layer located on a surface of the flexible pressurizable membrane layer.

8. The structure of claim 1 further comprising a frame located within the second volume.

9. The structure of claim 1 further comprising a frame located between the first wall and the second wall.

10. The structure of claim 1 wherein the control system is further configured to alter a mass of gas in the first volume.

11. The structure of claim 10 wherein the control system further comprises a pump, compressor, or vent valve.

12. The structure of claim 1 further comprising a spin section located within the second volume and configured to rotate around an axis of the second volume.

13. The structure of claim 1 further comprising an air lock that provides access between the second volume and the first volume between the first wall and the second wall.

14. The structure of claim 1 further comprising an air lock that provides access between the environment and the first volume between the first wall and the second wall.

15. The structure of claim 1 further comprising a third wall extending from the first wall to the second wall and enclosing a portion of the first volume between the first wall and the second wall thereby defining a cell between the first wall and the second wall.

16. The structure of claim 1 wherein distance between the first wall and the second wall is between 0.05 meters and 2 meters.

17. The structure of claim 1 further comprising a second sensor configured to detect an indication of a change in the second atmospheric pressure.

18. The structure of claim 1 wherein the first sensor comprises a strain gauge, pressure gauge, flow meter, temperature sensor or acoustic sensor.

19. The structure of claim 18 wherein the second sensor comprises a strain gauge, pressure gauge, flow meter, temperature sensor or acoustic sensor.

20. The structure of claim 1 further comprising:
a third wall comprising a sheet of flexible pressurizable membrane layer located within the first volume and attached at its edges to the first wall thereby creating a third volume, the third volume having a third atmospheric pressure that is less than or equal to the first atmospheric pressure and greater than the ambient atmospheric pressure.
